(19) United States
(12) Patent Application Publication
(10) Pub. No.: US 2025/0190603 A1
(43) Pub. Date: Jun. 12, 2025

(54) Data Protection Using Steganography and Machine Learning

(71) Applicant: Saudi Arabian Oil Company, Dhahran (SA)

(72) Inventors: Abdulmalik Abdulaziz Aljurayyad, Dammam (SA); Sultan Saadaldean Alsharif, Dammam (SA); John Gwilliams, Dhahran (SA)

(21) Appl. No.: 18/533,722

(22) Filed: Dec. 8, 2023

(51) Int. Cl. G06F 21/62

(52) U.S. Cl. CPC G06F 21/6218

(57) ABSTRACT

A computer implemented method that enables data protection using steganography and machine learning is described. The method includes obtaining a manipulated steganography image. The manipulated steganography image is input to a first trained machine learning model to recover the steganography image. The recovered steganography image is decoded using a second trained machine learning model.

### TECHNICAL FIELD

This disclosure relates generally to data protection using steganography and machine learning.

### BACKGROUND

Steganography is the technique of hiding data within other digital content including image, video, or audio content. Steganography enables the transmission of the hidden data without detection.

### BRIEF DESCRIPTION OF DRAWINGS

FIG. 1 shows a workflow that enables data protection using steganography and machine learning.

FIG. 2 shows an architecture that enables data protection using steganography and machine learning.

FIG. 3 shows stego-images.

FIG. 4 is a process flow diagram of a process that enables data protection using steganography and machine learning.

FIG. 5 illustrates hydrocarbon production operations that include both one or more field operations and one or more computational operations, which exchange information and control exploration for the production of hydrocarbons.

FIG. 6 is a schematic illustration of an example controller (or control system) for that enables data protection using steganography and machine learning.

### DETAILED DESCRIPTION

Data protection using steganography and machine learning is described. Steganography is used to securely exchange information between a sender and a receiver. In examples, the information is a message, image, or video concealed within another file, message, image, or video. The information is hidden within the file, message, image, or video, and the receiver extracts the message, image, or video using a steganography tool. Traditional steganography relies on passwords and encryption algorithms to protect the information from unauthorized receivers.

In embodiments, an additional layer of protection is applied to steganography images (e.g., stego-images, images that include a secret message, image, or video or other hidden protected, hidden information) by using image manipulation and machine learning. Image manipulation is applied to the stego-image using one or more image editing tools to manipulate the image. Image manipulations include, for example, image effects, filters, blurring, contrast, or any combinations thereof. In embodiments, an engine includes at least one trained machine learning model that identifies a manipulation (e.g., blurring pattern) of a stego-image by determining a manipulation key that has been applied to the stego-image.

Some advantages of the present techniques include an improvement to data protection by adding an additional manipulation to the stego-image prior to transmitting the stego-image to a receiver. Further. combining image manipulation and machine learning in a stego-image prevents decode of the stego-image to obtain the secret message by unauthorized receivers.

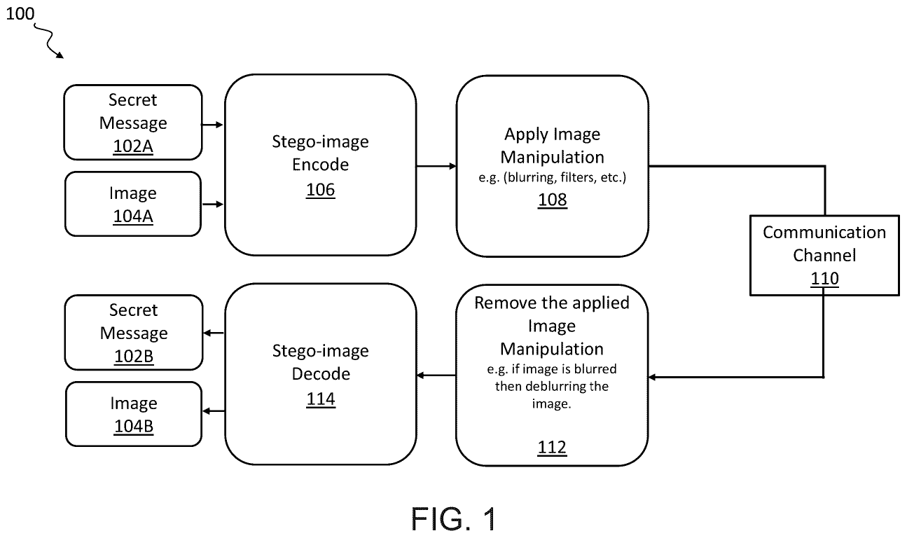

FIG. 1 shows a workflow that enables data protection using steganography and machine learning. As described in FIG. 1, the workflow 100 adds an additional layer of protection to the stego-image through image manipulation. A secret message 102A and an image 104A are encoded at block 106 into a stego-image. A secret message refers to data that is hidden within an image. In examples, the secret message includes data associated with the production of hydrocarbons. For example, the secret message is Automatic Meter Reading (AMR) data collected from various equipment and sensors, including flow meters, pressure sensors, temperature sensors, and tank level sensors. The image 104A may be, for example, a seismic image that includes detailed information about the structure of the subsurface, including buried faults, folds, salt domes, and the size, shape, and orientation of rock layers. The resulting stego-image refers to an image that is visually similar or the same as the original image 104A, and includes the secret message 102A embedded in the image.

At least one image manipulation is applied to the stego-image at block 108. The image manipulation may be, for example, transforming the stego-image by applying blurring, filters, adjusting contrast, and the like to the stego-image. In examples, a trained engine includes one or more manipulation keys that are applied to the stego-image. A manipulation key refers to a predetermined manipulation of an image. For example, the manipulation key may be a blur applied to the image at a predefined number or pattern of pixels.

The manipulated stego-image is transmitted to a receiver via a communication channel 110. In examples, the communication channel is a network that enables communication and the exchange of information between different entities with access to the network. The communication channel may be a Local Area Network (LAN), a Metropolitan Area Network (MAN), a Wide Area Network (WAN), a Wireless network, a Bluetooth based network, the Internet, or any combinations thereof.

At block 112, the image manipulation is removed from the received manipulated stego-image to recover the original stego-image. The recovered stego-image is the same as, equivalent to, or similar to the original stego-image manipulated at block 108. In examples, the image manipulation is removed by a first trained machine learning model that executes via a trained engine. For example, if the manipulated stego-image is blurred, then the manipulated stego-image is deblurred. If the manipulated stego-image is filtered, then the manipulated stego-image is unfiltered. If the contrast of the manipulated stego-image is adjusted, then the adjusted contrast of manipulated stego-image is removed. At block 114, the received stego-image is decoded to obtain the received secret message and the received image. In examples, a second trained machine learning model extracts the secret message from the recovered stego-image.

In examples, the trained engine comprises manipulation keys, trained machine learning models that identify and remove the manipulation applied to the stego-image according to the manipulation key, and also extract the secret message. The trained engine can be, for example, a desktop application, web server application, or mobile application. The trained engine can decode/encode secret messages in an image. In examples, at least one instance of the trained engine is associated with each entity (e.g., senders and receivers) on a network established by the communication channel 110. Each entity can encode and transmit manipulated stego-images using the trained engine, and each entity can receive and decode manipulated stego-images using the trained engine.

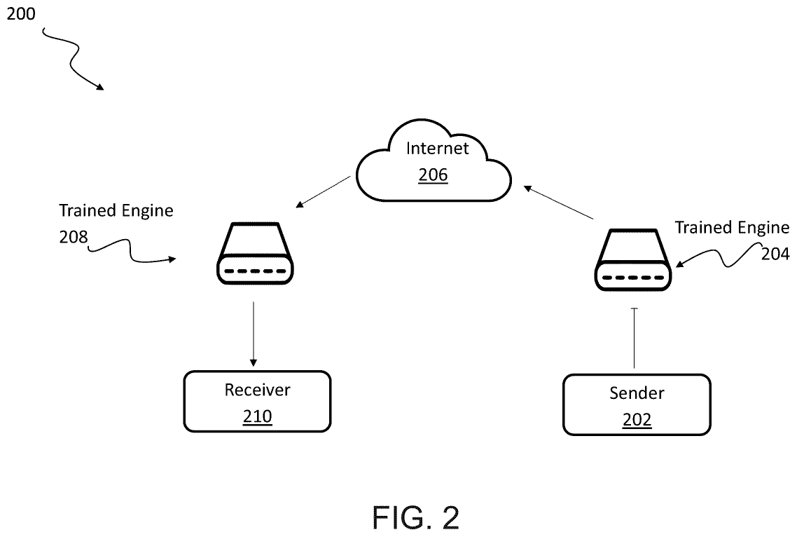

FIG. 2 shows an architecture that enables data protection using steganography and machine learning. In examples, the architecture 200 implements the workflow 100 of FIG. 1. As shown in FIG. 2, a sender 202 generates a stego-image that includes a secret message (e.g., secret message 102A of FIG. 1) encoded onto an image (e.g., image 104A of FIG. 1) using the trained engine 204. In examples, the sender 202 uploads the image and secret message into the trained engine 204. The trained engine embeds the secret message within the uploaded image and manipulates the resulting encoded image according to a manipulation key. In embodiments, the image manipulation applied to the stego-image output at block 106 is according to a predetermined manipulation key. In examples, the manipulation key is a specific blurring key that blurs the stego-image. Specific blurring pixels are selected to make the blurring an indicator that is distinguished during machine learning training. For example, the specific blurring pixels are a number of blurred pixels with a radius of 197 pixels. This results in a circular area of pixels that are blurred. Although particular patterns and numbers of blurred pixels are described, any number of blurred pixels and any patterns may be used according to the present techniques.

The manipulated stego-image is transmitted to a receiver 210 via a trained engine 208 on the network, such as the internet 206. The trained engine 208 includes a first trained machine learning model that is trained to identify the manipulation in the stego-image according to the manipulation key. In examples, the first trained machine learning model is a Convolutional Neural Network (CNN) that learns patterns and irregularities associated with at least one manipulation key. The trained engine 208 also includes a second trained machine learning model that is trained to extract the secret message from the stego-image. In examples, the second trained machine learning model is a CNN that captures patterns and irregularities that indicate the presence of secret messages.

A first machine learning model is trained to determine the stenography applied to image, and a second machine learning model is trained to decode the secret message from the stego-image. In examples, the machine learning models are trained using three datasets of images. A first dataset contains steganography images that include a predetermined type of encoding and a particular manipulation key (e.g., blurring key with a radius of 197 pixels). A second dataset contains generic and random steganography images. A third dataset contains images without steganography. In examples, the three datasets are used to train the machine learning models to remove image manipulation and extract the secret message from the stenographic image. In examples, the images of the three datasets are preprocessed to make them suitable for training and maintain the aspect ratio of the images. In addition, the datasets are labeled to distinguish between the three datasets of images.

The trained engine 208 identifies the pattern (blurred radius of 197 pixels) of the manipulation key using the first trained machine learning model and reverses the manipulation of the stego-image. The trained engine 208 generates a received stego-image from the manipulated stego-image by inputting the manipulated stego-image into the first trained machine learning model. The manipulated stego-image output by the first trained machine learning model is then decoded to obtain the original image and the secret message. In examples, the trained engine 208 decodes the stego-image by inputting the stego-image into a second trained machine learning model to obtain a secret message (e.g., secret message 102B of FIG. 1) and an image (e.g., image 104B of FIG. 1). The receiver 210 obtains the original secret message and original image.

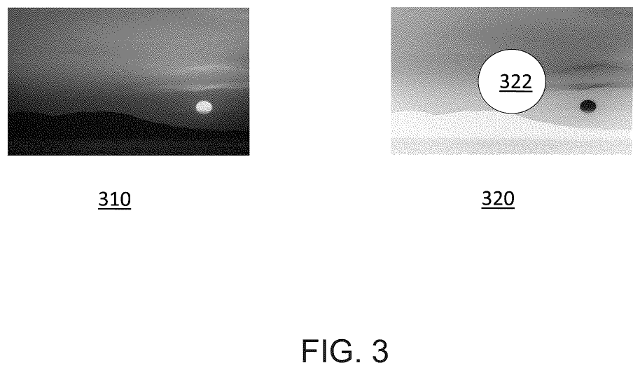

FIG. 3 shows an original stego-image 310 and a manipulated stego-image 320. In FIG. 3, the manipulated stego-image 320 is blurred using a blurring key with a radius of 197 pixels, resulting in the circular area 322 of the image that is blurred. In examples, blurring stego-image enables protection of the secret message in the stego-image so that unauthorized receivers cannot extract the secret message.

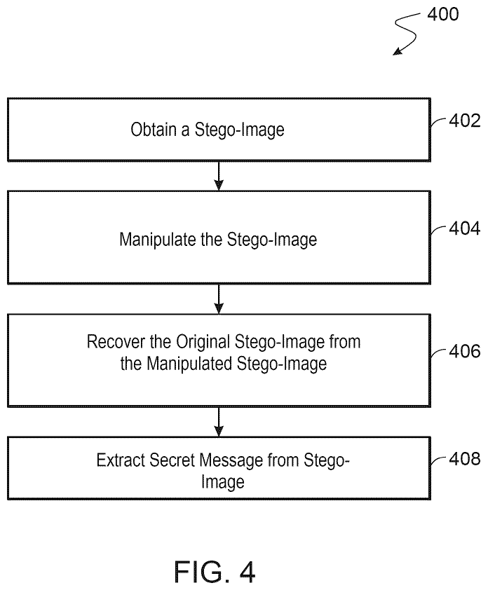

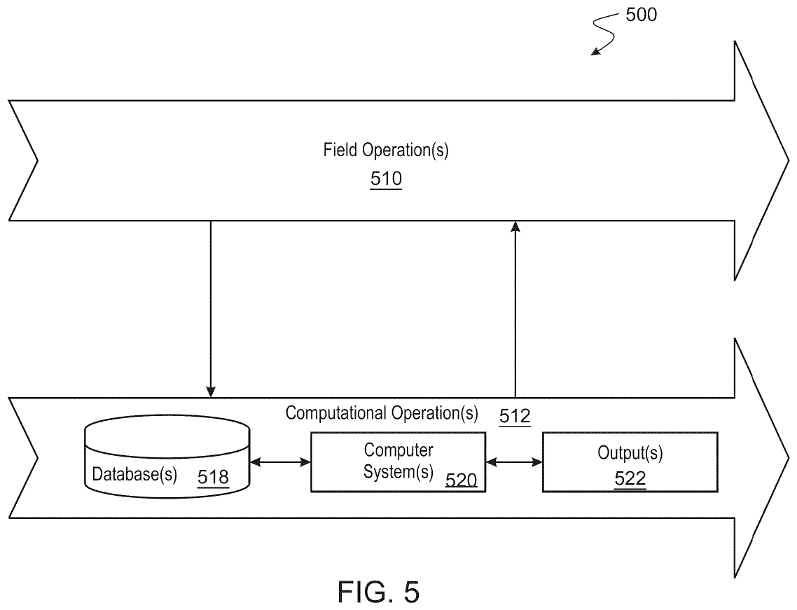

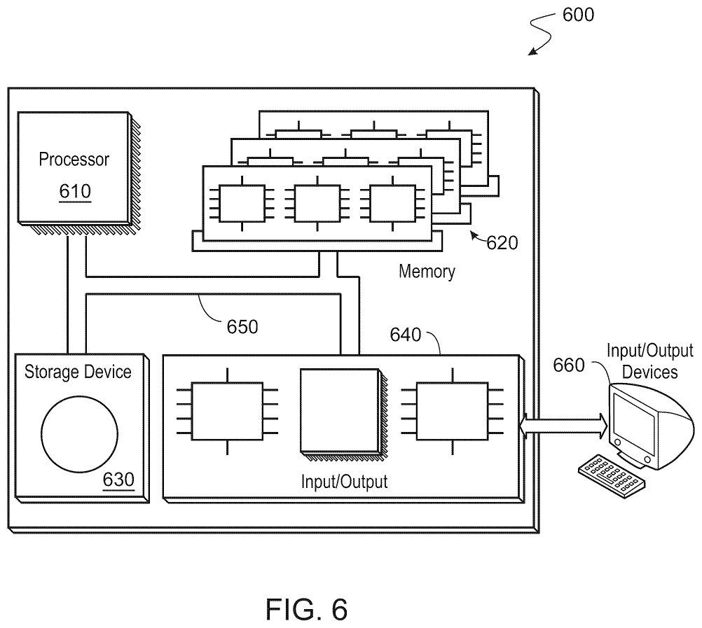

FIG. 4 is a process flow diagram of a process 400 that enables data protection using steganography and machine learning. In some embodiments, the process 400 may be implemented using the architecture 200 of FIG. 2. In some embodiments, the process 400 is used to protect data obtained during hydrocarbon production operations 500 of FIG. 5. Additionally, in some embodiments the process 200 is implemented by a controller 600 of FIG. 6.

At block 402, a stego-image is obtained. In embodiments, the stego-image is generated by encoding a secret message onto an image. In examples, the image is a seismic image that includes detailed information about the structure of the subsurface, including buried faults, folds, salt domes, and the size, shape, and orientation of rock layers. Additionally, in examples the secret message is AMR data collected from various equipment and sensors, including flow meters, pressure sensors, temperature sensors, and tank level sensors.

At block 404, image manipulation is applied to the stego-image based on at least one manipulation key, wherein the image manipulation is an image effect such as blurring, filters, etc. In examples, the manipulation key applies multiple effects to the stego-image.

At block 406, the manipulated stego-image is received, and the original stego-image is recovered from the manipulated stego-image using a first trained machine learning model. The manipulated stego-image is input to the first trained machine learning model, and the first trained machine learning model outputs the original stego-image, without image manipulation. In embodiments, the first machine learning model is trained using multiple datasets, wherein at least one dataset includes images manipulated using a manipulation key.

At block 408, the secret message is extracted from the recovered stego-image. In embodiments, the secret message is extracted from the stego-image using a second trained machine learning model. The recovered stego-image is input to the second trained machine learning model, and the second trained machine learning model extracts the secret message from the stego-image. In embodiments, the second machine learning model is trained using multiple datasets, wherein at least one dataset includes generic and random steganography images.

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 6 is a schematic illustration of an example controller 600 (or control system) for that enables data protection using steganography and machine learning. For example, the controller 600 may be operable according to the workflow 100 of FIG. 1, in the architecture 200 of FIG. 2, or the process 400 of FIG. 4. In some embodiments, the controller 600 is the same as or similar to the computer systems 520 of FIG. 5. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600 and one user can use multiple controllers 600.

### Embodiments

According to some non-limiting embodiments or examples, provided is a computer-implemented method that enables data protection using steganography and machine learning, comprising: obtaining, using at least one hardware processor, a manipulated steganography image, wherein the manipulated steganography image is a steganography image transformed using a manipulation key; inputting, using the at least one hardware processor, the manipulated steganography image to a first trained machine learning model to recover the steganography image, wherein the first trained machine learning model outputs a recovered steganography image; and decoding, using the at least one hardware processor, the recovered steganography image using a second trained machine learning model, wherein the decoding extracts a secret message embedded in the steganography image.

According to some non-limiting embodiments or examples, provided is an apparatus comprising a non-transitory, computer readable, storage medium that stores instructions that, when executed by at least one processor, cause the at least one processor to perform operations comprising: obtaining a manipulated steganography image, wherein the manipulated steganography image is a steganography image transformed using a manipulation key; inputting the manipulated steganography image to a first trained machine learning model to recover the steganography image, wherein the first trained machine learning model outputs a recovered steganography image; and decoding the recovered steganography image using a second trained machine learning model, wherein the decoding extracts a secret message embedded in the steganography image.

According to some non-limiting embodiments or examples, provided is a system, comprising: one or more memory modules; one or more hardware processors communicably coupled to the one or more memory modules, the one or more hardware processors configured to execute instructions stored on the one or more memory models to perform operations comprising: obtaining a manipulated steganography image, wherein the manipulated steganography image is a steganography image transformed using a manipulation key; inputting the manipulated steganography image to a first trained machine learning model to recover the steganography image, wherein the first trained machine learning model outputs a recovered steganography image; and decoding the recovered steganography image using a second trained machine learning model, wherein the decoding extracts a secret message embedded in the steganography image.

Further non-limiting aspects or embodiments are set forth in the following numbered embodiments:

Embodiment 1: A computer-implemented method that enables data protection using steganography and machine learning, including: obtaining, using at least one hardware processor, a manipulated steganography image, wherein the manipulated steganography image is a steganography image transformed using a manipulation key; inputting, using the at least one hardware processor, the manipulated steganography image to a first trained machine learning model to recover the steganography image, wherein the first trained machine learning model outputs a recovered steganography image; and decoding, using the at least one hardware processor, the recovered steganography image using a second trained machine learning model, wherein the decoding extracts a secret message embedded in the steganography image.

Embodiment 2: The computer implemented method of any preceding embodiment, wherein the manipulation key comprises specific blurring pixels in an area of the steganography image.

Embodiment 3: The computer implemented method of any preceding embodiment, wherein the manipulation key is a pattern of image effects applied to the steganography image.

Embodiment 4: The computer implemented method of any preceding embodiment, wherein the first trained machine learning model and the second trained machine learning model execute via a trained engine, wherein the trained engine comprises at least one manipulation key.

Embodiment 5: The computer implemented method of any preceding embodiment, wherein the steganography image is generated by encoding the secret message onto an original image.

Embodiment 6: The computer implemented method of any preceding embodiment, wherein the manipulation key applies multiple effects to the steganography image.

Embodiment 7: The computer implemented method of any preceding embodiment, wherein the steganography image is a seismic image.

Embodiment 8: An apparatus including a non-transitory, computer readable, storage medium that stores instructions that, when executed by at least one processor, cause the at least one processor to perform operations including: obtaining a manipulated steganography image, wherein the manipulated steganography image is a steganography image transformed using a manipulation key; inputting the manipulated steganography image to a first trained machine learning model to recover the steganography image, wherein the first trained machine learning model outputs a recovered steganography image; and decoding the recovered steganography image using a second trained machine learning model, wherein the decoding extracts a secret message embedded in the steganography image.

Embodiment 9: The apparatus of embodiment 8, wherein the manipulation key comprises specific blurring pixels in an area of the steganography image.

Embodiment 10: The apparatus of any preceding embodiment, wherein the manipulation key is a pattern of image effects applied to the steganography image.

Embodiment 11: The apparatus of any preceding embodiment, wherein the first trained machine learning model and the second trained machine learning model execute via a trained engine, wherein the trained engine comprises at least one manipulation key.

Embodiment 12: The apparatus of any preceding embodiment, wherein the steganography image is generated by encoding the secret message onto an original image.

Embodiment 13: The apparatus of any preceding embodiment, wherein the manipulation key applies multiple effects to the steganography image.

Embodiment 14: The apparatus of any preceding embodiment, wherein the steganography image is a seismic image.

Embodiment 15: A system, including: one or more memory modules; one or more hardware processors communicably coupled to the one or more memory modules, the one or more hardware processors configured to execute instructions stored on the one or more memory models to perform operations including: obtaining a manipulated steganography image, wherein the manipulated steganography image is a steganography image transformed using a manipulation key; inputting the manipulated steganography image to a first trained machine learning model to recover the steganography image, wherein the first trained machine learning model outputs a recovered steganography image; and decoding the recovered steganography image using a second trained machine learning model, wherein the decoding extracts a secret message embedded in the steganography image.

Embodiment 16: The system of embodiment 15, wherein the manipulation key comprises specific blurring pixels in an area of the steganography image.

Embodiment 17: The system of any preceding embodiment, wherein the manipulation key is a pattern of image effects applied to the steganography image.

Embodiment 18: The system of any preceding embodiment, wherein the first trained machine learning model and the second trained machine learning model execute via a trained engine, wherein the trained engine comprises at least one manipulation key.

Embodiment 19: The system of any preceding embodiment, wherein the steganography image is generated by encoding the secret message onto an original image.

Embodiment 20: The system of any preceding embodiment, wherein the manipulation key applies multiple effects to the steganography image.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a key board and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables data protection using steganography and machine learning, comprising:
obtaining, using at least one hardware processor, a manipulated steganography image, wherein the manipulated steganography image is a steganography image transformed using a manipulation key;
inputting, using the at least one hardware processor, the manipulated steganography image to a first trained machine learning model to recover the steganography image, wherein the first trained machine learning model outputs a recovered steganography image; and
decoding, using the at least one hardware processor, the recovered steganography image using a second trained machine learning model, wherein the decoding extracts a secret message embedded in the steganography image.

2. The computer implemented method of claim 1, wherein the manipulation key comprises specific blurring pixels in an area of the steganography image.

3. The computer implemented method of claim 1, wherein the manipulation key is a pattern of image effects applied to the steganography image.

4. The computer implemented method of claim 1, wherein the first trained machine learning model and the second trained machine learning model execute via a trained engine, wherein the trained engine comprises at least one manipulation key.

5. The computer implemented method of claim 1, wherein the steganography image is generated by encoding the secret message onto an original image.

6. The computer implemented method of claim 1, wherein the manipulation key applies multiple effects to the steganography image.

7. The computer implemented method of claim 1, wherein the steganography image is a seismic image.

8. An apparatus comprising a non-transitory, computer readable, storage medium that stores instructions that, when executed by at least one processor, cause the at least one processor to perform operations comprising:
obtaining a manipulated steganography image, wherein the manipulated steganography image is a steganography image transformed using a manipulation key;
inputting the manipulated steganography image to a first trained machine learning model to recover the steganography image, wherein the first trained machine learning model outputs a recovered steganography image; and
decoding the recovered steganography image using a second trained machine learning model, wherein the decoding extracts a secret message embedded in the steganography image.

9. The apparatus of claim 8, wherein the manipulation key comprises specific blurring pixels in an area of the steganography image.

10. The apparatus of claim 8, wherein the manipulation key is a pattern of image effects applied to the steganography image.

11. The apparatus of claim 8, wherein the first trained machine learning model and the second trained machine learning model execute via a trained engine, wherein the trained engine comprises at least one manipulation key.

12. The apparatus of claim 8, wherein the steganography image is generated by encoding the secret message onto an original image.

13. The apparatus of claim 8, wherein the manipulation key applies multiple effects to the steganography image.

14. The apparatus of claim 8, wherein the steganography image is a seismic image.

15. A system, comprising:
one or more memory modules;
one or more hardware processors communicably coupled to the one or more memory modules, the one or more hardware processors configured to execute instructions stored on the one or more memory models to perform operations comprising:
obtaining a manipulated steganography image, wherein the manipulated steganography image is a steganography image transformed using a manipulation key;
inputting the manipulated steganography image to a first trained machine learning model to recover the steganography image, wherein the first trained machine learning model outputs a recovered steganography image; and
decoding the recovered steganography image using a second trained machine learning model, wherein the decoding extracts a secret message embedded in the steganography image.

16. The system of claim 15, wherein the manipulation key comprises specific blurring pixels in an area of the steganography image.

17. The system of claim 15, wherein the manipulation key is a pattern of image effects applied to the steganography image.

18. The system of claim 15, wherein the first trained machine learning model and the second trained machine learning model execute via a trained engine, wherein the trained engine comprises at least one manipulation key.

19. The system of claim 15, wherein the steganography image is generated by encoding the secret message onto an original image.

20. The system of claim 15, wherein the manipulation key applies multiple effects to the steganography image.
